(19) United States
(12) Patent Application Publication
(10) Pub. No.: US 2016/0088972 A1
(43) Pub. Date: Mar. 31, 2016

(54) METHOD FOR PROVIDING COOKING PROGRAMS

(71) Applicant: Rational AG, Landsberg am Lech (DE)

(72) Inventors: Peter Wiedemann, Klosterlechfeld (DE); Torsten Brinkmann, Stoettwang (DE); Katrin Lauterbach, Landsberg am Lech (DE); Anja Machowetz, Surrey (GB); Juergen Klasmeier, Landsberg am Lech (DE); Thomas Schreiner, Kaufering (DE); Simone Roesler, Landsberg am Lech (DE); Judith Kling, Landsberg am Lech (DE); Martin Heinrich, Buxheim (DE)

(21) Appl. No.: 14/964,302

(22) Filed: Dec. 9, 2015

Related U.S. Application Data
(63) Continuation-in-part of application No. 13/816,930, filed on May 8, 2013.

(30) Foreign Application Priority Data
Aug. 13, 2010 (DE) 10 2010 036 988.8

(51) Int. Cl. A47J 27/62; A47J 27/14

(52) U.S. Cl. CPC A47J 27/62; A47J 27/14

(57) ABSTRACT

A method for providing cooking programs for at least one selectable product to be cooked, which can be cooked in at least two different charges in a cooking chamber of a cooking appliance. Cooking processes conducted depending on charge-dependent parameters are replaced by cooking programs that depend solely on fixed parameters. A cooking program is assigned to each charge respectively. A cooking process is conducted as a function of at least one charge-dependent parameter at least once for each charge, with a caliber-dependent parameter determined by a core temperature of the product to be cooked being selected as the charge-dependent parameter. A cooking process that leads to a specific cooking result is selected for each charge, with the cooking result being determined by the core temperature of the product and a cooking program being stored for each selected cooking process after the charge-dependent parameter is replaced by a fixed parameter.

### BACKGROUND

1. Technical Field

The present application relates to a method for providing cooking programs.

2. Description of the Related Art

In intelligent cooking appliances, such as the cooking appliance sold by the applicant under the trade name SelfCooking Center®, flexible cooking processes are used in order to be able to offer reproducible cooking results at any time, regardless of a charge quantity, type of product to be cooked, or the like. For this purpose, numerous decisions must be made by the operator, which for inexperienced users leads to problems. Thus, numerous simplifications for these cooking processes have been developed. For example, DE 10 2008 016 824 A1 by the applicant has, as its subject, the automation of cooking processes. More precisely, it is there recommended that different, manually conducted cooking programs are stored which are representative of different charges, such as a program on the one hand with a maximum load of a product to be cooked of a specific type of product to be cooked with a specific caliber and a specific initial state, and on the other hand, a program with a minimum load of the product to be cooked of the specific type of product to be cooked with the specific caliber and specific initial state, in order to conduct, on the basis of these two extreme cooking programs, an adjustment when conducting the same cooking program at a later time to the respective load with the same type of product to be cooked. Therefore, the entire middle range between the two extreme loads can be automated, in particular, via a linear adjustment of the values characteristic for the cooking programs, such as cooking duration, the temperature in the cooking chamber, and/or the humidity in the cooking chamber. This method, thus, provides a simplification of the operation of a cooking appliance.

EP 2 469 173 A2 of the applicant teaches a method for guiding a cooking process within a cooking chamber of a cooking appliance based on a determined specific heat input into a product to be cooked. In order to obtain a heat flux integral, the specific heat input is integrated over the cooking time and the cooking process is terminated as soon as a certain heat flux integral has been reached. The specific heat input is obtained by multiplying the heat transfer co-efficient of the cooking process with the difference between the temperature within the cooking chamber and a temperature of the product to be cooked, in particular the surface temperature of said product. For further details reference is made to EP 2 469 173 A2, the disclosure of which is incorporated into the present application.

### BRIEF SUMMARY

The present application offers a method for providing cooking programs which simplifies the operation of a cooking appliance due to the fact that the number of inputs on the cooking appliance is as low as possible. In particular, an operator need only select one product to be cooked in order to achieve the same cooking result at all times, with all variants of the charge in the cooking chamber of the cooking appliance with this product to be cooked. This is of particular importance, in particular, for use in restaurant chains.

The present application is thus based on a surprising finding that cooking processes that are conducted depending on charge-dependent parameters, in other words, in particular, core temperature-dependent processes, can be replaced by programs that depend only on fixed parameters, in particular, which are purely time-controlled. More precisely, the present application recommends that the cooking processes that are provided by an intelligent cooking appliance, which are respectively compiled from a process tree with respective decision criteria in the cooking process, can be used by a supervisor of a restaurant chain or a program developer and modified by entering cooking parameters such as the internal cooking degree and/or external cooking degree, until a desired cooking result is provided for a specific product to be cooked with a specific charge. For example, here the cooking processes are conducted in each case in dependence on core temperature measurements. As soon as a cooking process has been found to be in order, in other words, when it leads to a satisfactory cooking result, the cooking duration recorded for this cooking process is determined, for example, and is stored as the fixed parameter of a cooking program for the product in question to be cooked with the charge in question. If cooking programs have been stored for all possible charge variants, an operator or user could simply retrieve the respective cooking program, namely by selecting the product to be cooked, together with its charge, and if appropriate, entering insertion levels of a cooking chamber which have been charged with the product to be cooked.

As the charge can vary in numerous ways, the present application proposes that the charge can be recorded via a sensor device, namely on the basis of the heat input into the product to be cooked, in particular, in order to determine the heat flux integral as known from EP 2 469 173 A2. In case the variation of the charge of the product to be cooked by the operator or user in comparison to the charge of the product having been cooked by the supervisor in order to obtain the fixed parameter exceeds a certain threshold value, the cooking program can be adapted such that at the end thereof the heat input into the product is in both cases the same. Having an identical heat input goes together with an identical cooking result. Thus, erroneous entry by the operator or user is now almost completely impossible, so that reproducible cooking results are achieved. Due to the provision of cooking programs according to the present application, a way is pre-selected by an experienced operator, such as a supervisor, for an inexperienced operator, in other words, a standard user, in the process tree of a cooking program which is in general provided.

Often a cooking process comprises a plurality of cooking steps, e.g., a first step for a gentle pre-heating of a food item at a low temperature and a high relative humidity and a second step for a browning of said food item at a high temperature and a low relative humidity. According to the present application, it is possible that a time duration as well as a specific heat input is determined and stored either for only one of said cooking steps or for both of said cooking steps at the end of the cooking process, with the one cooking step and both cooking steps having been conducted dependent on a core temperature of the food item, respectively. The stored cooking program comprises the same plurality of cooking steps as the cooking process, and a specific heat input into the food item to be cooked is determined for at least one cooking step corresponding to the at least one cooking step of the cooking process for which the time duration as well as the specific heat input has been stored, such that the cooking program can be adapted for the at least one cooking step dependent on the stored time duration as well as the result of the comparison of the determined heat input with the stored heat input.

Naturally, the cooking programs can be altered by the supervisor or developer at any time in order to store alternative cooking programs. In order to make the work of the supervisor or developer easier, information on the respective cooking process or cooking progress can be displayed on a display device of a cooking appliance. A display of a plurality of cooking processes can be given, for example in tabular form, in order to make it easier to select an optimum cooking process.

An access authorization check can be used to decide whether the person operating the appliance is a supervisor, operator or user.

### BRIEF DESCRIPTION OF THE SEVERAL VIEWS OF THE DRAWINGS

Further features and advantages of the invention will be given in the description below, in which exemplary embodiments of the invention will be explained as examples with reference to the schematic drawings appended, in which:

FIG. 1 shows cooking processes as they are conducted by a supervisor or developer; and

FIGS. 2a and 2b show cooking programs such as those initiated by an operator or user.

### DETAILED DESCRIPTION

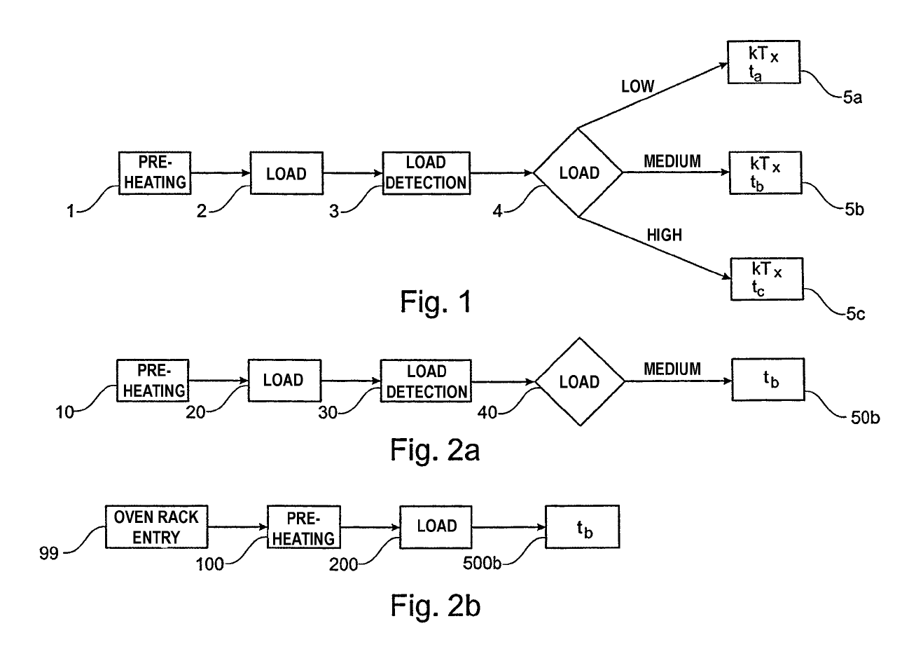

A supervisor of a restaurant chain can, for example, operate a cooking appliance sold by the applicant under the trade name SelfCooking Center® (not shown) in such a manner that he/she first selects a type of product to be cooked, such as poultry parts (not shown), as well as first such poultry parts with a first charge or load. An intelligent cooking process in accordance with FIG. 1 then begins with a pre-heating stage 1, wherein a display is shown after a specific pre-heating temperature has been reached that now the first poultry parts can be loaded into the cooking chamber of the cooking appliance. Following the corresponding loading stage 2, a charge or load detection stage 3 begins, wherein, for example, it is detected on the basis of the progression of the heat input into the first product whether there is a low, medium, or high load in the cooking chamber. A low load can, for example, be present when one or two oven racks are loaded in a cooking chamber into which six oven racks can be inserted, while a middle load is present when three or four oven racks are loaded, and a high load is present when five or six oven racks are loaded with the first product to be cooked, said first product being of a standard caliber and a frozen initial state, for example.

Depending on the detected load, a core temperature-controlled cooking process is then conducted, for example, wherein for this purpose, the supervisor must have specified a desired core temperature and, thus, a desired internal cooking degree. With a fixed specified cooking chamber temperature and a fixed specified humidity in the cooking chamber, as well as a fixed specified set value of the core temperature, the time duration tₐ, t_{b} or t_{c} for each one of the low, medium and high load will be different until the set value in question is reached for different charges, as is shown by stages 5ₐ, 5_{b} and 5_{c}. More precisely, tₐ<t_{b}<t_{c}, when tₐ corresponds to a low load, t_{b} corresponds to a medium load, and t_{c} corresponds to a high load.

A supervisor can conduct several cooking processes in accordance with FIG. 1 and after the respective cooking result has been appraised, he/she can assign a different rating to each cooking process. The supervisor can then select the cooking process with the best rating in order to store a cooking program which is based on this process, in which a cooking duration is stored for the product to be cooked as first parameter, wherein the cooking duration depends on the charge, in other words, in the example shown in FIG. 1, it is either tₐ, t_{b}, or t_{c}. A charge-dependent second parameter is determined by the heat input into the product and stored, in addition, for each of the three loads, namely low, medium and high load.

The supervisor can conduct the cooking processes in accordance with FIG. 1 solely on the basis of an access authorization check, so that cooking programs can only be stored which have been found to be in order by the supervisor. An operator is not granted access to this level and can only retrieve the stored cooking programs. For this purpose, the operator must select the product to be cooked, in other words, in this case the poultry parts, so that then the cooking program shown in FIG. 2 runs automatically.

With the cooking program shown in FIG. 2a, a pre-heating stage 10 first takes place, following which a loading request is made with the loading stage 20 which is followed by a load detection stage. Following the load detection, the suitable cooking program is selected automatically, and the suitable cooking duration thus occurs in stage 40. According to FIG. 2a, a medium load is present, for example, such as when three oven racks of the cooking appliance have been loaded with the product to be cooked, so that the cooking duration t_{b} is selected in accordance with stage 50b.

With the alternative shown in FIG. 2b, a user must first select a second product to be cooked, here poultry parts, and can then enter the number of oven racks to be charged with the poultry parts, for example three oven racks, see stage 99. A pre-heating stage 100 is then conducted and a loading request is made, see loading stage 200. The cooking program is then purely time-controlled, and in such a manner that with three oven racks, the total time t_{b} is selected, see stage 500b. In case the caliber of the second poultry parts being cooked is smaller or larger than the caliber of the first poultry parts used by the supervisor, an adaption of the cooking program will take place in accordance with the present application. In order to determine said adaption, the heat input into the second poultry parts is measured and compared to the heat input measured during the cooking process for the medium load conducted by the supervisor. In fact, the heat flux integral as a function of time is obtained in both cases such that the actual heat flux integral can be compared with the stored heat flux integral in order to determine a deviation which has to be compensated for. Such a compensation can be achieved by adapting the climate in the cooking chamber. If, for example, the gradient of the heat flux integral over time is too low, the circulation rate and/or temperature of the atmosphere within the cooking chamber can be enhanced such that at the end of the program, namely at t_{b}, the heat flux integral of the time-controlled cooking program corresponds to the heat flux integral at the end of the cooking process conducted by the supervisor.

Therefore, for a restaurant chain, a selected person, namely the supervisor, can, for example, firmly specify how desired cooking results should look by conducting a plurality of cooking processes with different products to be cooked and different charges, and making relevant decisions respectively for these during the progress of the cooking processes, in order to then store simple cooking programs which require a minimum number of decisions, since they run in a purely time-controlled manner. The supervisor, thus, specifies a procedure from which a user cannot deviate, in order to ensure that the cooking quality remains constant.

The features disclosed in the above description, in the claims, and in the drawings can be essential both individually and in any combination required for the implementation of the invention in its different embodiments.

1. A method for providing cooking programs for products of at least one selectable food type to be cooked, wherein products of a selected food type can be cooked in at least two different charges in a cooking chamber of a cooking appliance, and a charge is determined by a parameter characterizing at least one of a quantity of the product to be cooked, a caliber of the product to be cooked, and an initial state of the product to be cooked, wherein the method comprises:
selecting a cooking process for a first product of a selected food type with a selected first charge, said cooking process leading to a specific cooking result and being conducted at least once as a function of at least one charge-dependent parameter, wherein the at least one charge-dependent parameter is a core temperature of the first product;
detecting at least once a specific heat input into the first product during completion of the cooking process;
after completion of the cooking process, storing a cooking program based on a completed cooking process together with at least
i) a first parameter determined by a time duration of the cooking process, and
ii) a second parameter determined by the specific heat input;
when the stored cooking program is later retrieved, conducting the stored cooking program for cooking a second product not as a function of the core temperature of the second product, but dependent on the first parameter;
determining at least once a specific heat input into the second product while conducting the stored cooking program for obtaining a third parameter;
comparing the second parameter and the third parameter; and
while conducting the stored cooking program, adapting the cooking program based on a result of the comparison.

2. The method according to claim 1, wherein the first parameter is a time duration for at least which the second product must be cooked.

3. The method according to claim 2, wherein
the time duration of the cooking program for cooking the second product corresponds to the time duration of the cooking process for cooking the first product when an absolute difference between the second and the third parameters, or between slopes of the second and the third parameters as a function of time, is below a threshold value.

4. The method according to claim 2, wherein, when the absolute difference between the second and the third parameters or between the slopes of the second and the third parameters as a function of time is above the threshold value, the time duration of the cooking program is prolonged or a climate in the cooking chamber during conducting of the cooking program is adapted.

5. The method according to claim 1, wherein:
each charge is entered via an input device or is recorded via a sensor device, and/or
each product to be cooked is entered via an input device or is recorded via a sensor device.

6. The method according to claim 1, wherein:
the specific heat input into the first product is integrated over time to obtain a first heat flux integral, with the first heat flux integral, or a time-dependent profile of the first heat flux integral, determining the second parameter, and
the specific heat input into the second product is integrated over time to obtain a second heat flux integral, with the second heat flux integral, or a time-dependent profile of the second heat flux integral, determining the third parameter.

7. The method according to claim 6, wherein when the second heat flux integral is below the first heat flux integral at the end of the time duration of the cooking process, the time duration of the cooking program is prolonged such that the cooking program is completed when the second heat flux integral corresponds to the first heat flux integral at the end of the cooking process.

8. The method according to claim 6, wherein, when a gradient of the second heat flux integral as a function of time differs from a gradient of the first heat flux integral as a function of time, a climate in the cooking chamber is adapted while conducting the stored cooking program.

9. The method according to claim 8, wherein the climate is adapted by adapting at least one of a temperature T, humidity H, circulation rate CR, pressure, or flow rate of the atmosphere within the cooking chamber such that a second heat flux integral E₂ corresponds to a first heat flux integral E₁ at the end of the cooking process, E₂ (t_{end})=E₁ (t_{end}).

10. The method according to claim 9, wherein
$$\frac{d {E}_{2}}{d t} \sim \frac{d {E}_{2}}{d t} \sim {CR}^{0.7} .$$

11. The method according to claim 9 wherein
$$\frac{d {E}_{1}}{d t} \sim T - F - {T}_{01} \sim \frac{d {E}_{2}}{d t} \sim T - F - {T}_{02} ,$$
with F being a charge dependent factor and T₀₁ being a surface temperature of the first product and T₀₂ being a surface temperature of the second product.

12. The method according to claim 1, wherein the second product is selected, and subsequently the cooking program runs automatically.

13. The method according to claim 1, wherein the cooking program is stored in a storage device, said the storage device being a portable storage device or a storage device in a personal computer or part of the cooking appliance.

14. The method according to claim 1, wherein the cooking result is determined by an internal cooking temperature or a browning of a surface of the first product in addition to the core temperature.

15. The method according to claim 1, wherein the initial state of the product to be cooked is frozen or fresh.

16. The method according to claim 1, wherein:
the cooking process is conducted in a first cooking appliance, and
the cooking program is conducted in a second cooking appliance different from the first cooking appliance.

17. The method according to claim 16, wherein the first cooking appliance is connectable to the second cooking appliance, at least for periods of time, in a kitchen network.

18. The method according to claim 1, wherein:
the cooking process comprises a plurality of cooking steps, with the first parameter as well as the second parameter being stored for at least one of the cooking steps;
the cooking program comprises the same plurality of cooking steps as the cooking process, with the third parameter being determined for at least one cooking step corresponding to the at least one cooking step of the cooking process for which the first, as well as the second, parameter has been stored; and
the cooking program is adapted for the at least one cooking step dependent on the first parameter as well as the result of the comparison of the second and third parameters.

19. The method according to claim 1, wherein:
the cooking process comprises a plurality of cooking steps, with the first parameter as well as the second parameter being stored for each cooking step;
the cooking program comprises the same plurality of cooking steps as the cooking process, with the third parameter being determined for each cooking step; and
the cooking program adapted for each of its cooking steps dependent on the first parameter as well as the result of the comparison of the second and third parameters of each cooking step.

20. The method according to claim 2, wherein the time duration of the cooking program for cooking the second product corresponds to the time duration of the cooking process for cooking the first product.

21. The method according to claim 4, wherein the climate is adapted by adapting at least one of a temperature T, humidity H, circulation rate CR, pressure, or flow rate of the atmosphere within the cooking chamber such that a second heat flux integral E₂ corresponds to a first heat flux integral E₁ at the end of the cooking process, E₂ (t_{end})=E₁ (t_{end}).
